(19) United States
(12) Patent Application Publication
(10) Pub. No.: US 2017/0129035 A1
(43) Pub. Date: May 11, 2017

(54) PORTABLE WELDING SYSTEM WITH A POWER SUPPLY UNIT AND A DETACHABLE WIRE FEEDER UNIT

(71) Applicant: MK Products, Inc., Irvine, CA (US)

(72) Inventors: Christopher A. Westlake, Silverado, CA (US); Matthew A. Fiore, Rancho Santa Margarita, CA (US)

(21) Appl. No.: 14/935,682

(22) Filed: Nov. 9, 2015

(51) Int. Cl. B23K 9/10; B23K 9/12

(52) U.S. Cl. CPC B23K 9/1006; B23K 9/125

(57) ABSTRACT

There is provided a portable welding system that includes a power supply unit and a wire feeder unit. The power supply unit includes power supply electronics and a power supply housing sized and configured to house the power supply electronics. The power supply housing includes a base face and an opposing upper support face. The wire feeder unit is detachably engaged with the power supply unit. The wire feeder unit includes a welding gun hose connection port sized and configured for connection to a welding gun hose. The wire feeder unit further includes a wire spool and a wire feeder housing. The wire spool is attached to the wire feeder housing. The wire feeder housing has a bottom face and an opposing top face, and the wire feeder unit is detachably engaged with the power supply unit with the upper support face disposed adjacent the bottom face.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND

1. Technical Field

The present disclosure relates generally to welding systems, and more particularly, the present disclosure relates to a portable welding system with a power supply unit and detachable wire feeder unit.

2. Related Art

Materials can be joined together by welding them together with a melted filler material, such as steel or aluminum filler wire. This typically involves the use of a welding system to melt the filler wire at the junction of two materials that are to be joined. Arc welding is a type of welding that uses a welding power supply to create an electric arc between an electrode and the base material to the metals at a welding point. A typical arc welding system includes a welding gun and an electric power supply unit connected electrically to the welding gun by a connecting conduit to provide the welding gun with electrical energy. The power supply unit includes an electric power converter, which draws electrical energy from the mains and converts it to electrical energy suitable for supply to the welding gun. A wire feeder unit provides the filler wire to the welding gun. The wire feeder unit includes a spool of wire that is driven by a drive motor at a controlled rate to coupled welding gun.

A portable welding cart or frame may be provided that houses the power supply unit and the wire feeder unit. Additionally, a shielding gas may be provided to protect the weld location from impurities. In this regard, a gas tank or cylinder may be provided that is supported by the portable welding cart or frame. Further, cooling fluid may be pumped to and from the welding gun and the associated apparatus may also be stored aboard the portable welding cart or frame.

The overall welding cart or frame may be provided with wheels to provide a limited degree of mobility with the welding gun and supporting filler wire and electric conduits allowing for additional localized range of motion. However, the overall welding cart may become too cumbersome or difficult to gain access for the desired welding location. There are practical limitations to the length of filler wire and electric conduits connected to the welding gun.

In view of the foregoing, there is a need in the art for improved mobility of a welding system in comparison to the prior art.

### BRIEF SUMMARY

In accordance with one embodiment, there is provided a portable welding system that includes a power supply unit and a wire feeder unit. The power supply unit includes power supply electronics and a power supply housing sized and configured to house the power supply electronics. The power supply housing includes a base face and an opposing upper support face. The wire feeder unit is detachably engaged with the power supply unit. The wire feeder unit includes a welding gun hose connection port sized and configured for connection to a welding gun hose. The wire feeder unit further includes a wire spool and a wire feeder housing. The wire spool is attached to the wire feeder housing. The wire feeder housing has a bottom face and an opposing top face, and the wire feeder unit is detachably engaged with the power supply unit with the upper support face disposed adjacent the bottom face.

According to another embodiment, the power supply unit may further include wheels rotatably coupled to the power supply housing adjacent the base face. The portable welding system may further include a latching mechanism sized and configured to retain the wire feeder unit adjacent the power supply unit with the bottom face against the upper support face. The latching mechanism may include a catch and a slide bolt sized and configured to be engageable with the catch for retaining the wire feeder unit adjacent the power supply unit with the bottom face against the upper support face. The catch may be attached to the power supply unit and the slide bolt may be attached to the wire feeder unit. The slide bolt may have an extended position with the slide bolt being engageable with the catch. The slide bolt may be biased in the extended position. The latching mechanism may include a spring sized and configured to bias the slide bolt in the extended position. The bottom face may include a generally horizontal portion and an angled portion, and the angled portion may extend from the horizontal portion towards the top face. The horizontal portion may be disposed between the latching mechanism and the angled portion. The portable welding system may further include a retention component sized and configured to retain the wire feeder unit adjacent the power supply unit with the bottom face against the upper support face. The retention component may include a prong and slot sized and configured to be engageable with the prong for retaining the wire feeder unit adjacent the power supply unit. The prong may extend from the power supply housing and the slot is formed in the wire feeder housing. The wire feeder unit may further include a handle disposed at the top face of the wire feeder housing. The portable welding system may further include a gas cylinder support attached to the power supply housing, and the gas cylinder support may be sized and configured to support a gas cylinder thereupon.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a portable welding system according to an embodiment of the invention as shown with a gas cylinder (shown in phantom lining);

FIG. 2 is a reverse perspective view of the portable welding system of FIG. 1;

FIG. 3 is the perspective view of the portable welding system of FIG. 1 (without the gas cylinder) with a wire feeder unit exploded from a power supply unit and a partial portion of a welding gun hose attached to the wire feeder unit;

FIG. 4 is the perspective view of the portable welding system of FIG. 1 with portions of a housing of the wire feeder and the power supply unit removed;

FIG. 5 is an enlarged view of a portion of the wire feeder unit of FIG. 4 with a latching mechanism depicted;

FIG. 6 is an enlarged view of a portion of the wire feeder unit and power supply unit with the wire feeder unit being shifted away from the power supply unit; and

FIG. 7 is a side view of the power of the wire feeder unit and power supply unit of FIG. 6 as viewed along axis 7-7, however with the wire feeder unit being engaged with the power supply unit.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities.

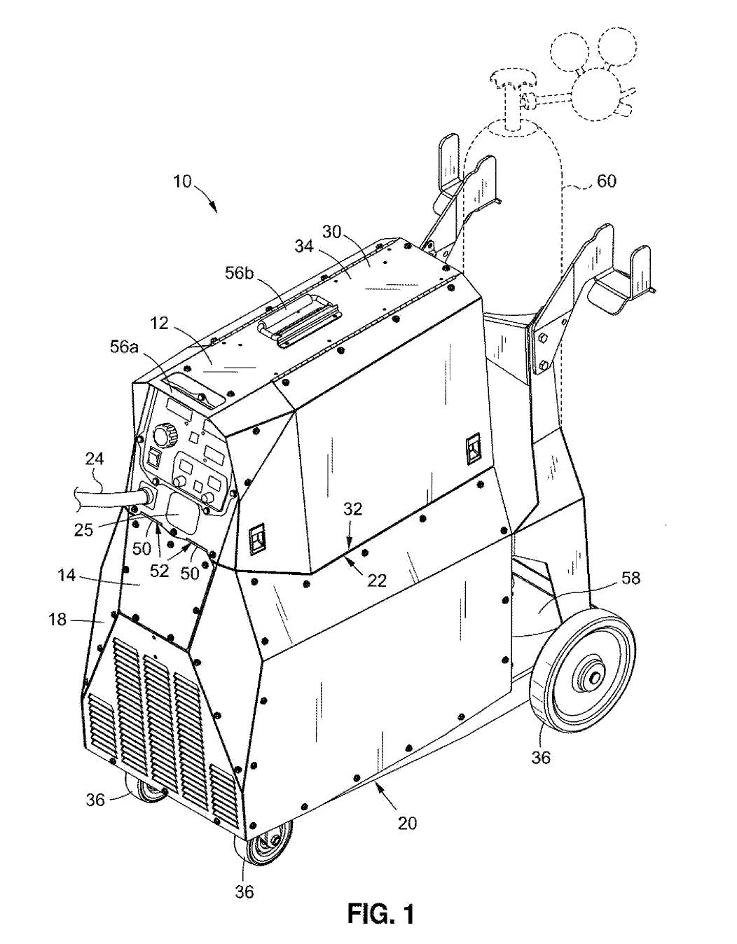

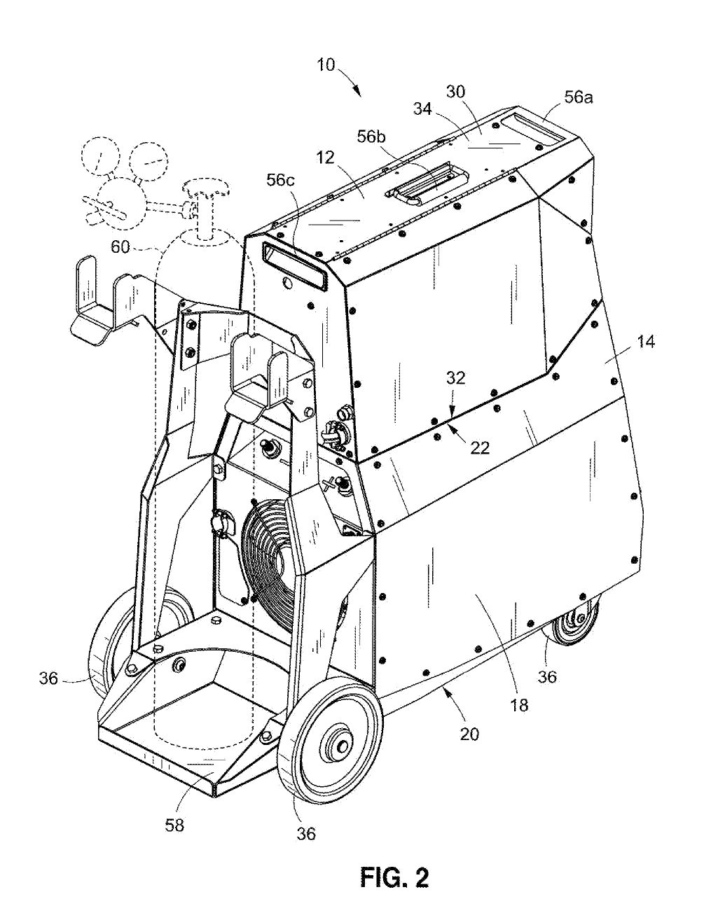

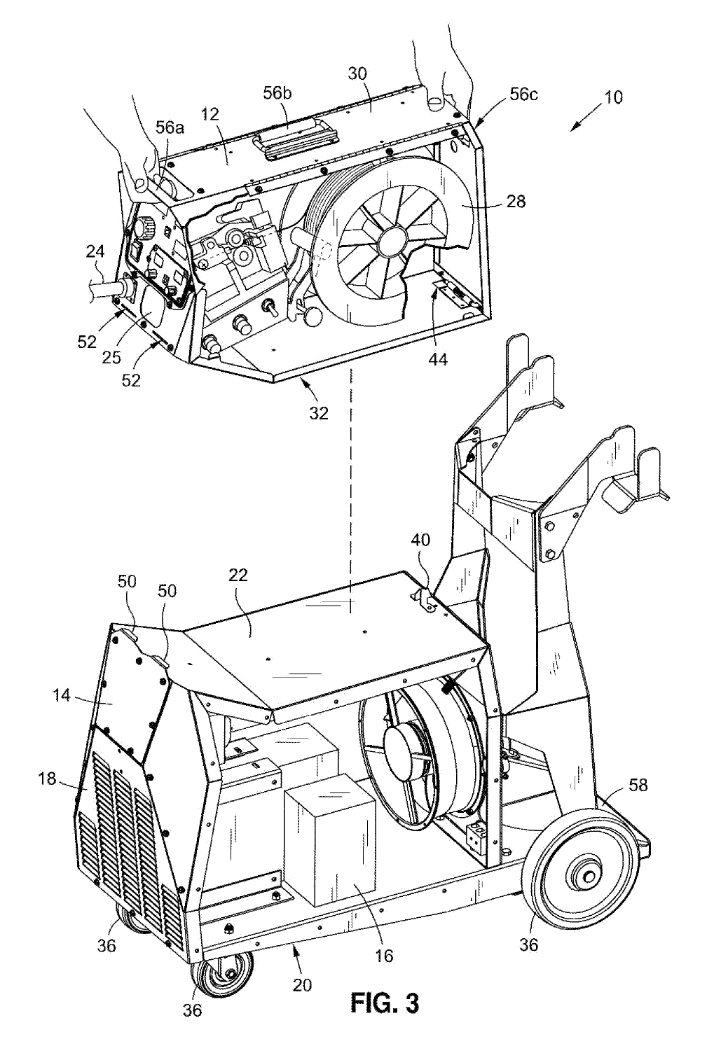

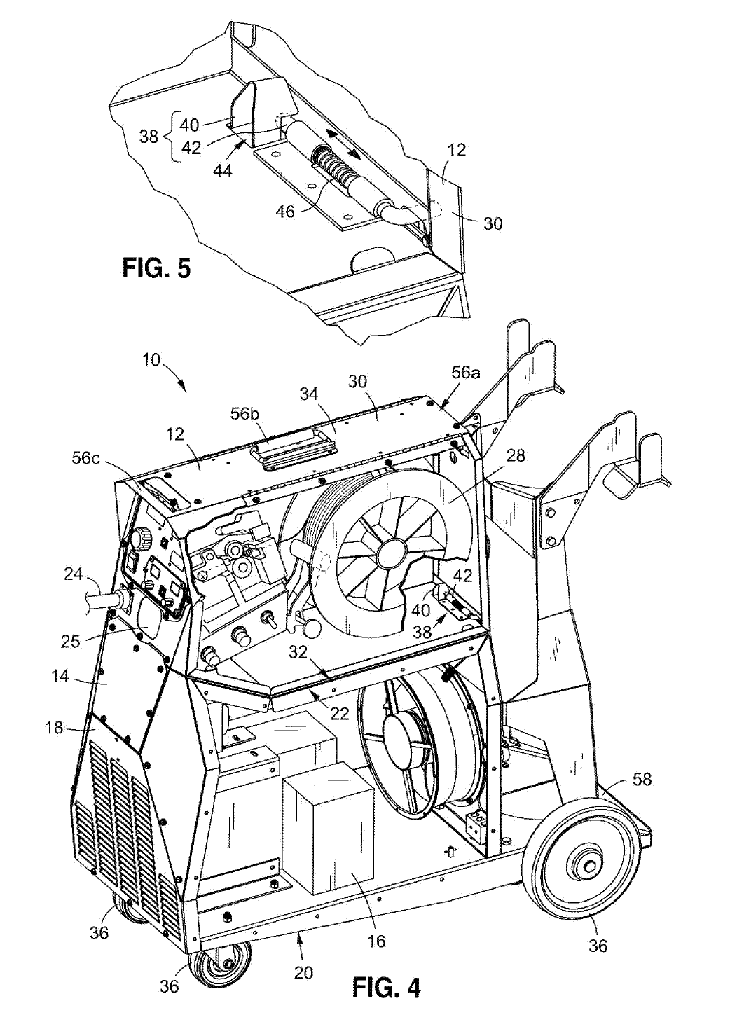

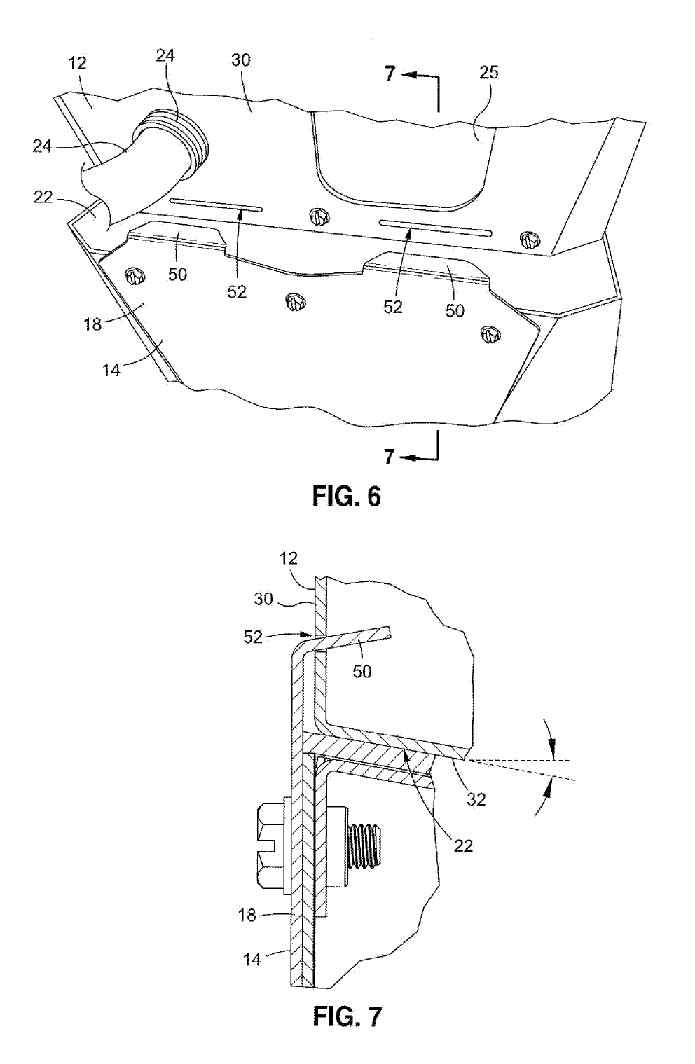

Referring now to FIGS. 1-4, there is depicted a portable welding system 10 according to an embodiment of the invention. FIG. 1 is a perspective view of the portable welding system 10. FIG. 2 is a reverse perspective view of the portable welding system 10 of FIG. 1. FIG. 3 is the perspective view of the portable welding system 10 with a wire feeder unit 12 exploded from a power supply unit 14 and FIG. 4 is the portable welding system 10 with the wire feeder unit 12 engaged with the power supply unit 14 with portions of the housings of the wire feeder unit 12 and the power supply unit 14 being removed to allow for viewing of the internal components thereof.

In accordance with one embodiment, there is provided the portable welding system 10 that includes the power supply unit 12 and the wire feeder unit 14. The power supply unit 14 includes power supply electronics 16 and a power supply housing 18 sized and configured to house the power supply electronics 16. The power supply housing 18 includes a base face 20 and an opposing upper support face 22. The wire feeder unit 12 is detachably engaged with the power supply unit 14. The wire feeder unit 12 includes a welding gun hose connection port 25 sized and configured for connection to a welding gun hose (not shown) as well as an electrical power cord port 24 to provide electric power to the wire feeder unit 14. The wire feeder unit 12 further includes a wire spool 28 and a wire feeder housing 30. The wire spool 28 is attached to the wire feeder housing 30. The wire feeder housing 30 has a bottom face 32 and an opposing top face 34. The wire feeder unit 12 is detachably engaged with the power supply unit 14 with the upper support face 22 disposed adjacent the bottom face 32.

According to various embodiments, the welding system 10 may be mobile in nature. In this regard, the power supply unit 14 may include wheels 36 rotatably coupled to the power supply housing 18 adjacent the base face 20.

As mentioned above the wire feeder unit 12 is detachably engaged with the power supply unit 14. As used herein the term “detachably engaged” refers to the wire feeder unit 12 being able to be detached from the power supply unit 14 and reattached to the power supply unit 14 without either of the wire feeder unit 12 or the power supply unit 14 having to be disassembled. In this regard, “detachably engaged” refers to being able to be readily disengaged and reengaged. It is contemplated that the wire feeder unit 12 being detachably engaged with the power supply unit 14 is particularly advantageous as this facilitates the range and accessibility to possible welding locations to be greatly extended.

In an embodiment, the portable welding system 10 may further include a latching mechanism 38 sized and configured to retain the wire feeder unit 12 adjacent the power supply unit 14 with the bottom face 32 against the upper support face 22. FIG. 5 is an enlarged view of a portion of the wire feeder unit 12 of FIG. 4 with the latching mechanism 38 depicted. In this view the latching mechanism 38 is in a latched state with the power supply unit 14 being retained adjacent the power supply unit 14. The latching mechanism 38 includes a catch 40 and a slide bolt 42 sized and configured to be engageable with the catch 40 for retaining the wire feeder unit 12 adjacent the power supply unit 14 with the bottom face 32 against the upper support face 22. The catch 40 is attached to the power supply unit 14 and extends from the power supply housing 18 from the upper support face. The slide bolt 42 is attached to the wire feeder housing 30 of the wire feeder unit 12. The slide bolt 42 is slidably mounted to the power supply housing 18. The bottom face 32 may include an opening 44 formed therein. The catch 40 and the opening 44 may be cooperatively formed to allow the catch 40 to extend through the opening 44 upon the wire feeder unit 12 being placed upon the power supply unit 14. The slide bolt 42 has an extended position with the slide bolt 42 being engageable with the catch 40. The slide bolt 42 may be biased in the extended position. The latching mechanism 38 may include a spring 46 sized and configured to bias the slide bolt 42 in the extended position.

With the latching mechanism 38 in the latched state with the wire feeder unit 12 engaged with the power supply unit 14, in order to initiate a detachment of the wire feeder unit 12 from the power supply unit 14, a user would move the slide bolt 42 to an unlatched state by sliding the slide bolt 42 away from the catch 40. In the enlarged view of FIG. 5, this would entail the slide bolt 42 being slid along its longitudinal axis downward to the right (which would simply be a horizontal movement of the slide bolt 42). This would allow the slide bolt 40 to eventually clear the catch 40 upon upward movement of the slide bolt 40 upon the wire feeder unit 12 being lifted. The movement of the slide bolt 42 would be resisted by the compression of the spring 46.

In the particular embodiment discussed above, it is understood that the latching mechanism 38 facilitates the wire feeder unit 12 to be detachably engaged with the power supply unit 14. It is contemplated that one of ordinary skill in the art could modify the depicted latching mechanism 38 to have different components located at differing positions and even other latching arrangements, such as other latches, catches, fasteners, hooks, closures, magnets, and the like which may be chosen from those which are well known to one of ordinary skill in the art.

The portable welding system 10 may further include a retention component 48 sized and configured to retain the wire feeder unit 12 adjacent the power supply unit 14 with the bottom face 32 against the upper support face 22. As mentioned above, the latching mechanism 38 facilitates the wire feeder unit 12 to be detachably engaged with the power supply unit 14. However, the retention component 48 may also facilitate another manner in which the wire feeder unit 12 is to be detachably engaged with the power supply unit 14.

The retention component may include a prong and a slot, or a pair of prongs 50 and a pair of slots 52 as depicted. The slots 52 are each sized and configured to be engageable with a corresponding one of the prongs 50 for retaining the wire feeder unit 12 adjacent the power supply unit 14. Each prong 50 may extend from the power supply housing 18 and the slots 52 may be formed in the wire feeder housing 30. The prongs 50 may be configured to generally extend in a horizontal direction. In this regard upon being engaged with the slots 52, this prong/slot arrangement restricts the movements of the wire feeder unit 12 from being detached from the power supply unit 14, except in a direction from which the prongs 50 are inserted into the slots 52 in the horizontal direction.

The wire feeder unit 12 may further include one or more handles, such as handles 56a-c disposed at the top face 34 of the wire feeder housing 12. It is contemplated that in reattaching the wire feeder unit 12 to the power supply unit 14, the user may hold any of the handles 56a-c and move the wire feeder unit 12 generally above and close to the upper support face 22 of the power supply unit 14. The user would then align the slots 52 with the prongs 50 and move the wire feeder unit 12 generally in a horizontal direction for engagement of the prongs 50 in each of their corresponding slots 52. Next, the user would slide the slide bolt 42 to an unlatched state and lower a portion of the wire feeder unit 12 with the catch 40 extending through the opening 44. The slide bolt 42 would then be released and the spring 46 would then bias the slide bolt in the latched position thereby retaining the wire feeder unit 12 adjacent the power supply unit 14.

The bottom face 32 may include a generally horizontal portion 54 and an angled portion 56. The angled portion 56 may extend from the horizontal portion 54 towards the top face 34. The horizontal portion 54 may be disposed between the latching mechanism 38 and the angled portion 56. It is contemplated that the angled portion 54 visually helps the user to readily recognize the overall orientation of the wire feeder unit 12 for reattachment to the power supply unit 14. Moreover, the angled portion 54 may further visually and intuitively aid the user to guide the slots 52 towards the prongs 50 for engagement.

It is contemplated that the wire feeder unit 12 includes the necessary and appropriate components to facilitate spooling/braking of welding wire from the wire spool 28, supporting electrical components for connection to the welding gun hose connection port 24 and/or a welding gun (not depicted), and related electronic controls for the forgoing, as may be selected from those well known to one of ordinary skill in the art. Similarly, it is contemplated that the power supply unit 14 includes the necessary and appropriate components to generate and control electrical output needs from the power supply electronics 16 (as symbolically depicted), such as transformers/power converters and the like and related electrical controls and conduits for connection to and through the wire feeder unit 12 and/or directly to the desired welding location, as may be selected from those well known to one of ordinary skill in the art.

The portable welding system 10 may further include a gas cylinder support 58 attached to the power supply housing 18, and the gas cylinder support 58 may be sized and configured to support a gas cylinder 60 thereupon (as depicted in dashed lining in FIG. 2). The gas cylinder 60 may be used to supply shielding gas as may be required for specific welding needs. Though not depicted, it is contemplated that other components used in the welding process may be stored on or within either of the wire feeder unit 12 or power supply unit 14, such as cooling fluids used to cool the welding gun. In this respect the portable welding system 10 may facilitate mobility of all or at least substantially all of the equipment needed by a user to perform the desired welding tasks at the desired locations.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A portable welding system comprising:
a power supply unit including power supply electronics and a power supply housing sized and configured to house the power supply electronics, the power supply housing including a base face and an opposing upper support face; and
a wire feeder unit detachably engaged with the power supply unit, the wire feeder unit including a welding gun hose connection port sized and configured for connection to a welding gun hose, the wire feeder unit further including a wire spool and a wire feeder housing, the wire spool being attached to the wire feeder housing, the wire feeder housing having a bottom face and an opposing top face, the wire feeder unit being detachably engaged with the power supply unit with the upper support face disposed adjacent the bottom face.

2. The portable welding system of claim 1 wherein the power supply unit further includes wheels rotatably coupled to the power supply housing adjacent the base face.

3. The portable welding system of claim 1 further includes a latching mechanism sized and configured to retain the wire feeder unit adjacent the power supply unit with the bottom face against the upper support face.

4. The portable welding system of claim 3 wherein the latching mechanism includes a catch and a slide bolt sized and configured to be engageable with the catch for retaining the wire feeder unit adjacent the power supply unit with the bottom face against the upper support face.

5. The portable welding system of claim 4 wherein the catch is attached to the power supply unit and the slide bolt is attached to the wire feeder unit.

6. The portable welding system of claim 4 wherein the slide bolt has an extended position with the slide bolt being engageable with the catch.

7. The portable welding system of claim 6 wherein the slide bolt is biased in the extended position.

8. The portable welding system of claim 7 wherein the latching mechanism includes a spring sized and configured to bias the slide bolt in the extended position.

9. The portable welding system of claim 3 wherein the bottom face includes a generally horizontal portion and an angled portion, the angled portion extends from the horizontal portion towards the top face.

10. The portable welding system of claim 9 wherein the horizontal portion is disposed between the latching mechanism and the angled portion.

11. The portable welding system of claim 3 further includes a retention component sized and configured to retain the wire feeder unit adjacent the power supply unit with the bottom face against the upper support face, the retention component includes a prong and slot sized and configured to be engageable with the prong for retaining the wire feeder unit adjacent the power supply unit.

12. The portable welding system of claim 1 further includes a retention component sized and configured to retain the wire feeder unit adjacent the power supply unit with the bottom face against the upper support face, the retention component includes a prong and slot sized and configured to be engageable with the prong for retaining the wire feeder unit adjacent the power supply unit.

13. The portable welding system of claim 12 wherein the prong extends from the power supply housing and the slot is formed in the wire feeder housing.

14. The portable welding system of claim 1 wherein the bottom face includes a generally horizontal portion and an angled portion, the angled portion extends from the horizontal portion towards the top face.

15. The portable welding system of claim 1 wherein the wire feeder unit includes a handle disposed at the top face of the wire feeder housing.

16. The portable welding system of claim 1 further includes a gas cylinder support attached to the power supply housing, the gas cylinder support sized and configured to support a gas cylinder thereupon.
